(19) United States
(12) Patent Application Publication
(10) Pub. No.: US 2016/0081386 A1
(43) Pub. Date: Mar. 24, 2016

(54) METHOD OF TRANSFORMING EGGS INTO A CONVENIENT FINGER FOOD

(71) Applicant: Wesley Richard JOHNSTON, West Deptford, NJ (US)

(72) Inventor: Wesley Richard JOHNSTON, West Deptford, NJ (US)

(21) Appl. No.: 14/863,907

(22) Filed: Sep. 24, 2015

Related U.S. Application Data
(60) Provisional application No. 62/054,769, filed on Sep. 24, 2014.

(51) Int. Cl. A23L 1/32; A23L 1/00; A23B 5/04

(52) U.S. Cl. CPC A23L 1/32; A23B 5/041; A23L 1/005; A23L 1/0073; A23V 2002/00

(57) ABSTRACT

A method of transforming eggs into a convenient finger food is provided. The method may have multiple stages, including at least two steps involving freezing of the egg product that is intermediately steam cooked, breaded and deep fried.

### CROSS-REFERENCE TO RELATED APPLICATION

This application claims the benefit of priority of U.S. provisional application No. 62/054,769, filed 24 Sep. 2014, the contents of which are herein incorporated by reference.

### BACKGROUND OF THE INVENTION

The present invention relates to food preparation and, more particularly, to a method of transforming eggs into a convenient finger food.

For those on the go, for those engaged in multi-tasking, or for those who just want the convenience of eating a nutritious, delicious egg without using utensils, options are limited, and so they end up in the single-tasking environment of a sit-down restaurant applying fork and knife to their egg.

As can be seen, there is a need for a method of transforming eggs into a convenient finger food, so as to be sold in quick serve restaurants (QSR) and similar locations designed for fast-paced individuals, allowing them to use solely their hands and fingers to navigate the hand to mouth relationship when eating a nutritious, delicious egg.

### SUMMARY OF THE INVENTION

In one aspect of the present invention, a method of transforming eggs into a convenient finger food includes molding a liquid egg product for forming a convenient finger food shape; steaming the liquid egg product, forming a molded egg product; freezing the molded egg product, forming a frozen egg product; breading the frozen egg product, forming a breaded egg product; freezing the breaded egg product, forming a frozen breaded egg product; and deep-frying the frozen breaded egg product, forming the convenient finger food.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a schematic view of an exemplary embodiment of the present invention; and

FIG. 3 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of transforming eggs into a convenient finger food. The method may have multiple stages, including at least two steps involving freezing of the egg product that is intermediately steam cooked, breaded and deep fried.

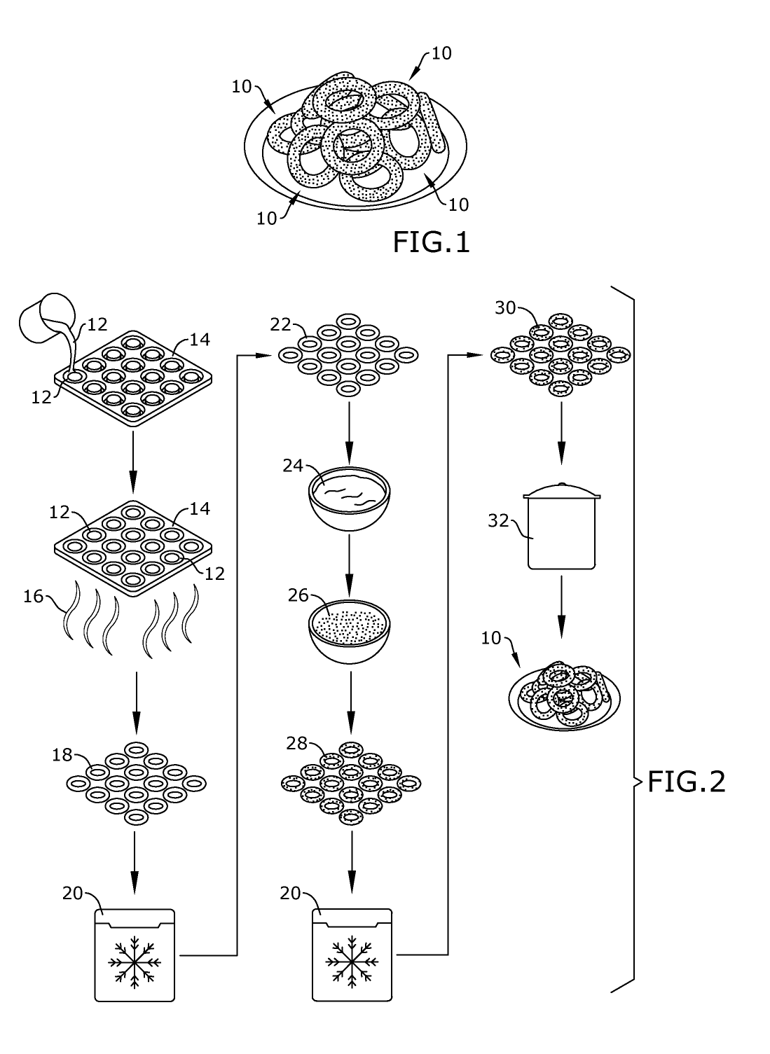

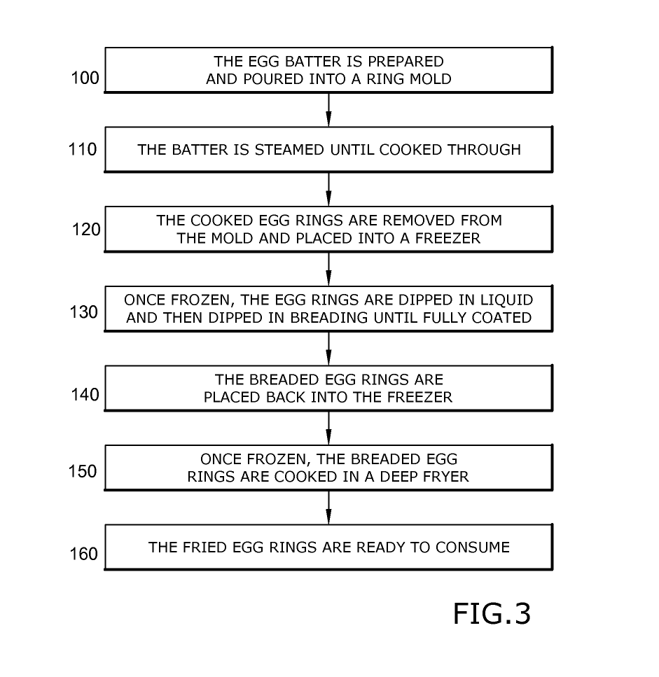

Referring to FIGS. 1 through 3, the present invention may include a method of transforming eggs into a convenient finger food 10. The method may include providing all items necessary to create the present invention, starting with plastic squeeze bottles (not shown), egg batter 12, at least one mold 14, a steamer (not shown), a freezer 20, a liquid 24, a breading mix 26 and a deep fryer 32.

The plastic squeeze bottles may include a squirt bottle adapted to urge the liquid 24 into narrow spaces. The egg batter 12 may include liquid egg products, such as whipped eggs, heavy cream and/or seasoning to preference. The at least one mold 14 may include a ring mold adapted to form annulus shapes; however, the at least one mold 14 may form any volumetric shape that lends itself to convenient finger food. The steamer may be adapted to produce steam 16, for example, from super heated water vaporizer. The freezer 20 may be adapted to safely keep uncooked product. The liquid 24 may include heavy cream, whipped egg and the like. The breading mix 26 may include garlic powder, onion powder, all purpose flour, Italian bread crumbs, and the like. The ingredients of the breading mix 26 may be adapted to form a coating similar in appearance to an onion ring. The deep fryer 32 may include deep fat fryer oil and a basket to hold food product in deep fat fryer.

In step 100 of the method, the egg batter 12 is prepared and poured in the at least one mold 14. Then, in step 110, the egg batter 12 is steamed until sufficiently cooked through by the application of steam 16, forming solidified and molded egg product 18. The molded egg product 18 is then removed from the at least one mold 14 and then placed in the freezer 20, in step 120. Once frozen, the frozen egg product 22 may be dipped in the liquid 24 and then dipped in the breading mix 26 until sufficiently coated, producing a breaded egg product 28, in step 130. In step 140, the breaded egg product 28 may be placed back in the freezer 20 for a predetermined freezing time for forming frozen breaded egg product 30. The predetermined freezing time may be just ‘once frozen.’ In step 150, the frozen breaded egg product 30 may be cooked in the deep fryer 32 for a predetermined frying time, resulting in the convenient finger food 10 of the present invention, in step 160.

The convenient finger food 10 may be sold in QSR and similar locations, allowing fast-paced individuals to consume nutritious and delicious egg products using solely their hands and fingers to consummating the hand to mouth relationship.

In an alternative embodiment, the method can include freezing the convenient finger food 10 for subsequent consumption.

Moreover, the convenient finger food 10 may take on the appearance of the breaded onion ring if the at least one mold 14 includes a ring mold.

It should be understood, of course, that the foregoing relates to exemplary embodiments of the invention and that modifications may be made without departing from the spirit and scope of the invention as set forth in the following claims.

What is claimed is:

1. A method of transforming eggs into a convenient finger food, comprising:
molding a liquid egg product for forming a convenient finger food shape;
steaming the liquid egg product, forming a molded egg product;
freezing the molded egg product, forming a frozen egg product; and
deep-frying the frozen egg product for a predetermined amount of time, forming the convenient finger food.

2. The method of claim 1, further comprising breading the frozen egg product, forming a breaded egg product; and
freezing the breaded egg product, forming a frozen breaded egg product to be deep-frying the frozen breaded egg product so as to form the convenient finger food.

3. The method of claim 1, further comprising providing a ring mold for forming an annulus shaped molded egg product.

4. The method of claim 3, further comprising providing a breading mix adapted to form a coating similar in appearance to an onion ring.

5. The method of claim 1, further comprising freezing the convenient finger food for subsequent consumption.

6. The method of claim 2, further comprising providing a ring mold for forming an annulus shaped molded egg product.

7. The method of claim 6, further comprising providing a breading mix adapted to form a coating similar in appearance to an onion ring.

8. The method of claim 2, further comprising freezing the convenient finger food for subsequent consumption.
